(19) United States
(12) Patent Application Publication
(10) Pub. No.: US 2023/0151500 A1
(43) Pub. Date: May 18, 2023

(54) NOVEL ELECTROCATALYTIC MEMBRANE REACTOR AND USE THEREOF IN PREPARATION OF HIGH-PURITY HYDROGEN

(71) Applicant: Tianjin University of Science and Technology, Tianjin (CN)

(72) Inventors: Zhen Yin, Tianjin (CN); Zhaohui Yin, Tianjin (CN); Ye Wang, Tianjin (CN); Hong Wang, Tianjin (CN); Jianxin Li, Tianjin (CN)

(21) Appl. No.: 18/146,277

(22) Filed: Dec. 23, 2022

Related U.S. Application Data
(63) Continuation of application No. PCT/CN2022/122047, filed on Sep. 28, 2022.

(30) Foreign Application Priority Data
Nov. 10, 2021 (CN) 202111325348.4

(51) Int. Cl. C25B 9/23; C02F 1/467; C02F 1/461; C25B 1/04

(52) U.S. Cl. CPC C25B 9/23; C02F 1/4672; C02F 1/46109; C25B 1/04; C02F 2101/345

(57) ABSTRACT

The disclosure provides a novel electrocatalytic membrane reactor and use thereof in preparation of high-purity hydrogen. The electrocatalytic membrane reactor adopts an H-shaped electrolytic tank in which a cathode chamber is isolated from an anode chamber through a diaphragm, a membrane electrode is used as an anode, an auxiliary electrode is used as a cathode, a direct-current regulated power supply supplies a constant current, and the flow of a reaction solution is realized through a pump. In the disclosure, electrocatalysis is coupled with a membrane separation function, an oxygen evolution reaction is replaced with an organic electrochemical oxidation reaction in the anode chamber so as to reduce the overpotential of the oxygen evolution reaction, and a hydrogen evolving reaction is performed in the cathode chamber to prepare high-purity hydrogen.

### CROSS-REFERENCE TO RELATED APPLICATIONS

This application is a continuation of International Patent Application No. PCT/CN2022/122047 with a filing date of Sep. 28, 2022, designating the United States, now pending, and further claims priority to Chinese Patent Application No. 202111325348.4 with a filing date of Nov. 10, 2021. The content of the aforementioned applications, including any intervening amendments thereto, are incorporated herein by reference.

### TECHNICAL FIELD

The disclosure belongs to the field of new energy, relates to an electrocatalytic membrane reactor and a preparation technology of high-purity hydrogen (with a purity of 99.9%), and particularly relates to a novel electrocatalytic membrane reactor and use thereof in preparation of high-purity hydrogen.

### BACKGROUD OF THE PRESENT INVENTION

As human society pays attention to clean energy and environmental protection, water treatment based on an electrocatalytic oxidation reaction and organic electrochemical synthesis have attracted extensive attentions from scientific research and industry in recent years. An electrocatalytic oxidation technology is a technology combining an electrochemical oxidation reaction with a heterogeneous catalytic reaction, its nature is that a catalyst is supported on an electrode and an oxidation reaction is achieved under the action of an electrical field, for example degradation or selective oxidation of organics. Therefore, the electrocatalytic oxidation technology has many advantages of mild reaction conditions, green cleaning and no oxidant addition and the like.

Although the electrocatalytic oxidation technology has many advantages, it still has shortcomings, for example electrode preparation is complicated and high in cost, and reactants fail to timely separate from products during the reaction so as to lead to a fact that the product cannot be regulated or its oxidation property is poor, thereby seriously affecting the efficiency of electrocatalytic oxidation and increasing its cost and energy consumption so that large-scale application is difficult to realize. The electrocatalytic membrane reactor combines a catalytic reaction and a membrane separation technology to realize the coupling of membrane separation with an electrochemical technology, thereby constructing the electrocatalytic membrane reactor, which can effectively solve the problems that transfer mass limitation exists in the electrochemical oxidation reaction, and the products cannot be timely separated to cause side reactions, and therefore not only retains the advantages of the traditional organic electrochemical synthesis but also inhibits side reactions and membrane pollution, and improves the efficiency of the reactor is improved by enhancing mass transfer.

However, the electrocatalytic membrane reactor still has disadvantages in the aspects of energy consumption and electrode reaction efficiency, for example, a large amount of hydrogen in the cathode reaction is wasted so as to cause high cost and energy consumption.

At present, the most widely applied hydrogen production technology is a technology for hydrogen production by electrolysis of water, including hydrogen production by electrolysis of water via alkaline water, hydrogen production by electrolysis of water via a proton exchange membrane and hydrogen production by electrolysis of water via high-temperature solid oxides. The hydrogen production by electrolysis of water via alkaline water is maturely developed, is the earliest technology, is high in commercialization degree at present and low in cost, and is a mode for hydrogen production from renewable energy. The hydrogen production by electrolysis of water via alkaline water generally uses the ion exchange membrane, but has the problems of slow response speed, alkali liquid loss and corrosion, high energy consumption and the like, is poor in volatility adaption, and needs stored energy when combing with wind and light. The hydrogen production by electrolysis water via solid oxide electrolyzed water needs high temperature, and has high requirements on equipment and larger technical difficulty, and has a harsh working environment, has relatively low technical maturity, and just stays in the concept of a laboratory. The hydrogen production by electrolysis of water via a proton exchange membrane has the characteristics of quick response speed, high running current density, low energy, high hydrogen production pressure, high produced hydrogen purity, adaption to volatility of renewable energy generation and easy combination with renewable energy consumption, hence, in recent years, the hydrogen production by electrolysis of PEM water has been rapidly developed. However, these reactors must use pure water as a water source, and the anode reaction can only be an oxygen evolution reaction, which has the problems of high overpotential, large energy consumption and the like.

### SUMMARY OF PRESENT INVENTION

The objective of the disclosure is to provide a novel electrocatalytic membrane reactor in which a cathode is isolated from an anode by utilizing a diaphragm, an oxygen evolution reaction is replaced with organic oxidation in the anode, and high-purity hydrogen is prepared in the cathode, in order to solve the problems existing in the prior art.

The disclosure provides a design of a novel electrocatalytic membrane reactor.

Another objective of the disclosure is to provide use of the novel electrocatalytic membrane reactor in preparation of high-purity hydrogen.

The above objectives of the disclosure are realized through the following solutions:

Provided is a reaction device of a novel electrocatalytic membrane reactor, comprising an electrolysis tank, a porous membrane electrode, a diaphragm, a pump direct-current stabilized power supply and the like. The novel electrolysis tank comprises an anode chamber, a cathode chamber and the diaphragm; the anode chamber comprises the porous membrane electrode, a reaction raw material liquid and an electrolyte solution; the cathode chamber comprises an auxiliary electrode and the electrolyte solution.

In the novel electrocatalytic membrane reactor, the porous membrane electrode is used as an anode, the auxiliary electrode is used as a cathode, the cathode is isolated from the anode by using the diaphragm and meanwhile the current efficiency is improved by utilizing anode and cathode reactions, a product is sucked to a permeation side through a negative pressure supplied by the pump under a certain working voltage and current density, so as to facilitate production of high-purity hydrogen by electrolysis of water in the cathode while realizing high-selective oxidation or efficient degradation of reactants.

The anode is a membrane electrode whose membrane can be a flat or tubular inorganic metal membrane, an oxide membrane or a carbon membrane.

The catalyst of the membrane electrode can be the membrane itself, or a notable metal and an oxide thereof (such as Pt, Ir and Ru), a transition metal oxide and a sulfide or a phosphide such as transition metal Ni, Co and Fe and multi-component oxides such as NiCoOₓ, which are supported on the membrane electrode.

In the H-shaped electrolytic tank, the cathode chamber is isolated from the anode chamber by a diaphragm which can be an ion exchange membrane or a proton exchange membrane.

The cathode can be a metal electrode, such as a stainless steel wire, foamed nickel and a metal titanium sheet, or a graphite electrode.

The anode is configured to perform organic degradation based on electrochemical oxidation, such as degradation of phenol and acid orange, or preparation of an oxygen-containing compound, such as preparation of aldehyde, acid and other products by oxidation of benzyl alcohol, ethanol, furfural and other organics; the cathode is configured to preparation of high-purity hydrogen.

The ion exchange membrane or the proton exchange membrane is used as the diaphragm, which not only isolates the cathode from the anode to form two independent reaction chambers but also separates the gas in the anode from hydrogen in the cathode so that more than 99% of high-purity hydrogen is produced. If there is no diaphragm between the cathode and the anode, the reactors is equivalent to an ordinary single tank by which high-purity hydrogen cannot be obtained by separation. In the disclosure, the utilization rate of the anode is improved, organic oxidation in the anode is coupled with hydrogen production in the cathode, the selectivity of the product or mineralization of difficultly degraded organics and evolution of hydrogen are regulated by regulating the types of porous membrane electrodes and catalysts, the voltage of the reactor, current density and the flow rate of the pump, thereby realizing electrochemical oxidation and preparation of high-purity hydrogen.

In the disclosure, the membrane electrode is used as the anode, electrocatalysis is coupled with the membrane separation function, and therefore the oxygen evolution reaction is converted into organic oxidation, in such a way, the reactor based on the electrocatalytic membrane electrode and the proton exchange membrane not only has the advantages of the traditional proton exchange membrane electrolysis tank: high produced hydrogen purity, large current density, quick response and easy combination with renewable energy, but also possesses the advantages of low energy consumption and cost of hydrogen production and the like. More important, such the membrane reactor can use sewage containing difficultly degraded organics such as phenol and dye as the water source, thereby not only reducing the energy consumption and cost of water treatment but also greatly decreasing the overpotential and energy consumption of the anode reaction and hydrogen cost. Meanwhile, such the membrane reactor can be combined with organic electrochemical synthesis so that electrochemical oxidative synthesis of organics is combined with hydrogen production, which not only reduces the energy consumption and cost of hydrogen production but also gains target products in the anode, for example oxygen-containing organics such as aldehyde and acid, thereby further reducing hydrogen production cost and promoting economic benefits.

To sum up, the disclosure has the following advantages:

(1) the novel electrocatalytic membrane reactor provided by the disclosure operates at room temperature and normal pressure, the membrane electrode is used as the anode so as to realize the double function of electrocatalysis and membrane separation, the oxidation reaction process is controllable, and degradation of difficultly degraded organics or selective oxidation reaction of organics can be efficiently realized.

(2) the cathode uses the commercialized metal electrode or the carbon electrode, so the cost is low, furthermore, production of high-purity hydrogen greatly improves the efficiency of the reactor so as to reduce the cost and energy consumption.

(3) the cathode is isolated from the anode by using the proton exchange membrane, the anode uses difficultly degraded organic sewage such as phenol and dye as the water source, which not only reduces the energy consumption and cost of water treatment but also decreases the overpotential of the anode reaction. The combination of electrochemical oxidative synthesis of organics with hydrogen production not only reduces the energy consumption and cost of hydrogen production but also gains the target products in the anode, thereby further reducing the cost of hydrogen production and promoting the economic benefits.

### DESCRIPTION OF THE DRAWINGS

FIG. 1A is a diagram of an H-shaped tubular membrane electrocatalytic membrane reactor;

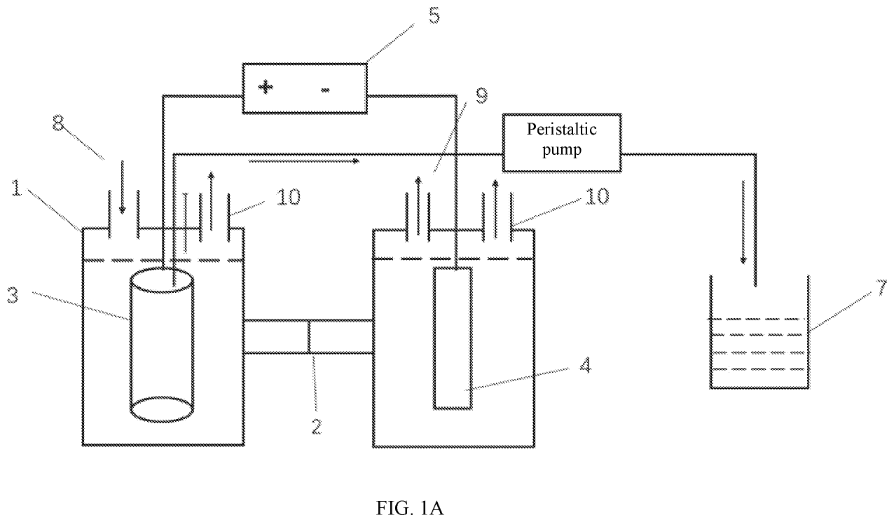

In the figure, 1, H-shaped electrolysis tank; 2, proton exchange membrane; 3, tubular membrane electrode as an anode; 4, metal electrode as a cathode; 5, direct current stabilized power supply; 6, peristaltic pump; 7, reactant product collection device; 8, feed liquid port; 9, discharge liquid port; 10, gas outlet.

FIG. 1B is a diagram of a flat membrane electrocatalytic membrane reactor;

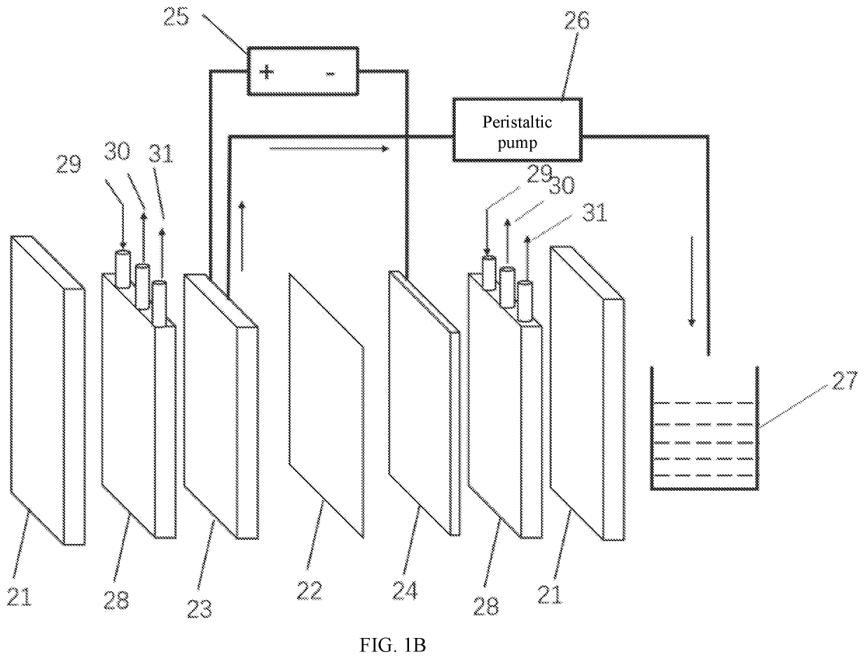

In the figure, 21, end plate; 22, proton exchange membrane; 23, flat membrane electrode as an anode; 24, metal electrode as a cathode; 25, direct current stabilized power supply, 26, peristaltic pump; 27, reactant product collection device; 28, pole plate; 29, feed liquid port; 30, discharge liquid port; 31, gas outlet.

FIG. 2 shows a relationship between reaction retention time and COD as well as hydrogen production rate in example 1.

FIG. 3 is a comparison picture of a dye solution before and after treatment.

FIG. 4 is a relationship diagram between current density and dye decolorization rate as well as chemical oxygen demand (COD).

FIG. 5 is a total organic carbon (TCD) graph of high-purity hydrogen.

### DETAILED DESCRIPTION OF PREFERRED EMBODIMENTS

The technical solution of the disclosure will be further described in detail in combination with specific embodiments.

### EXAMPLE 1

Treatment of phenol-containing wastewater with H-shaped electrocatalytic membrane reactor

An electrocatalytic membrane reactor was constructed by using a porous titanium membrane supported with a cobalt oxide nano catalyst as an anode, a stainless steel wire as a cathode and an H-shaped electrolysis tank. A diaphragm used a Nafion proton exchange membrane, a stable current was supplied by a direct current power supply, a membrane operation process used a dead end filtration mode, one end of the membrane was closed, the other end of the membrane was connected with a peristaltic pump through a pipeline, and a negative pressure was continuously supplied by the pump to enhance its mass transfer process. The initial concentration of phenol was 2 mmolL⁻¹, the concentration of electrolyte was 14.4 gL⁻¹ Na₂SO₄, the current density of the membrane reactor was 1.0 mAcm⁻², the retention time was 15 min, the removal rate of COD was 99%, the removal rate of TOC was 90%, and the yield of hydrogen per unit membrane area was 10 mL/h. When the reactor device was magnified to 10 folds, the yield of hydrogen was 100 mL/h, so as to realize the efficient treatment of phenol-containing wastewater and efficient hydrogen production.

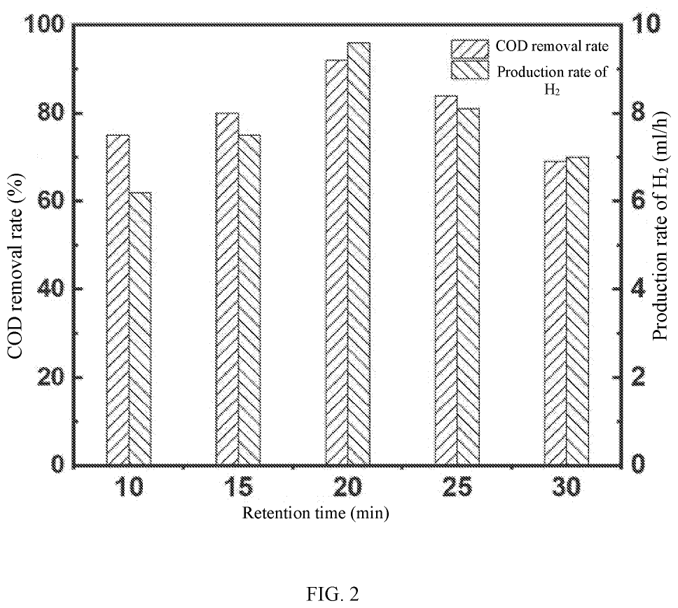

A relationship between reaction retention time and COD as well as a hydrogen production rate is as shown in FIG. 2.

### EXAMPLE 2

Treatment of azo dye wastewater coupled with hydrogen production with H-shaped electrocatalytic membrane reactor

An electrocatalytic membrane reactor was constructed by using a porous titanium membrane supported in situ with a cobalt oxide nano catalyst as an anode, a stainless steel wire as a cathode and an H-shaped electrolysis tank. A diaphragm used proton exchange membrane Nafion117, a stable current was supplied by a direct current power supply, a membrane operation process used a dead end filtration mode, one end of the membrane was closed, the other end of the membrane was connected with a peristaltic pump through a pipeline, and a negative pressure was continuously supplied by the pump to enhance its mass transfer process. The initial concentration of acid orange II was 10 mmolL⁻¹, the concentration of electrolyte was 14.4 gL⁻¹ Na₂SO₄, the current density of the membrane reactor was 1.0 mAcm⁻², the retention time was 20 min, the decolorization rate after reaction was 100%, the removal rate of COD was 99%, the removal rate of TOC was 90%, and the hydrogen production rate was close to 100 mL/h. Through the disclosure, the efficient removal of acid orange II simulated azo dye wastewater and the production of high-purity hydrogen are realized.

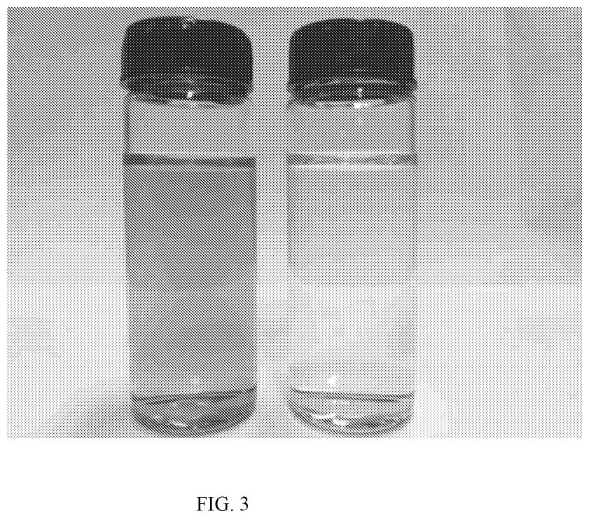

Comparison pictures of a dye solution before and after treatment are as shown in FIG. 3.

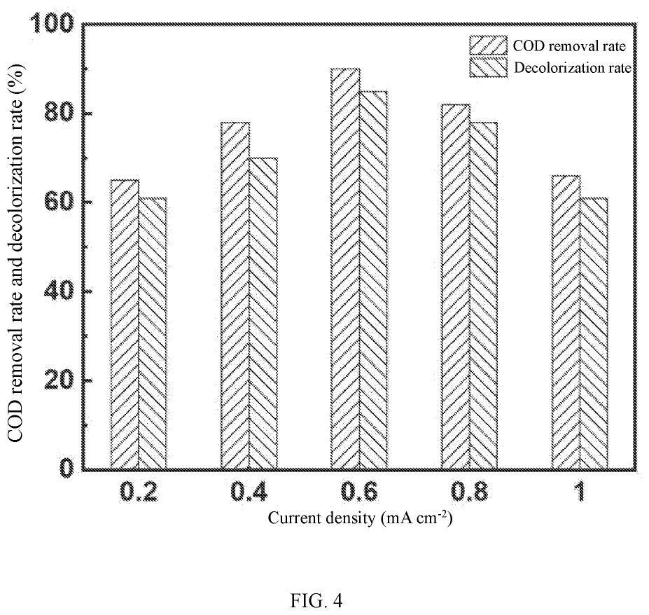

A relationship between current density and dye decolorization rate as well as COD is as shown in FIG. 4.

### EXAMPLE 3

Preparation of benzoic acid coupled with hydrogen production by electrocatalytic oxidation of benzyl alcohol with H-shaped electrolytic tank electrocatalytic membrane reactor.

An electrocatalytic membrane reactor was constructed by using a porous titanium membrane supported in situ with a cobalt oxide nano catalyst as an anode, a stainless steel wire as a cathode and an H-shaped electrolysis tank. A diaphragm used a Nafion proton exchange membrane, a stable current was supplied by a direct current power supply, a membrane operation process used a dead end filtration mode, one end of the membrane was closed, the other end of the membrane was connected with a peristaltic pump through a pipeline, and a negative pressure was continuously supplied by the pump to enhance its mass transfer process. The initial concentration of benzyl alcohol was 10 mmolL⁻¹, the concentration of electrolyte was 4 gL⁻¹ NaOH, the current density of the membrane reactor was 2.0 mAcm⁻², the retention time was 20 min, the conversion rate of benzyl alcohol was 90%, the selectivity of benzoic acid was 99%, and the hydrogen production rate was 100 mL/h. The electrochemical synthesis of benzoic acid and production of high-purity hydrogen are realized.

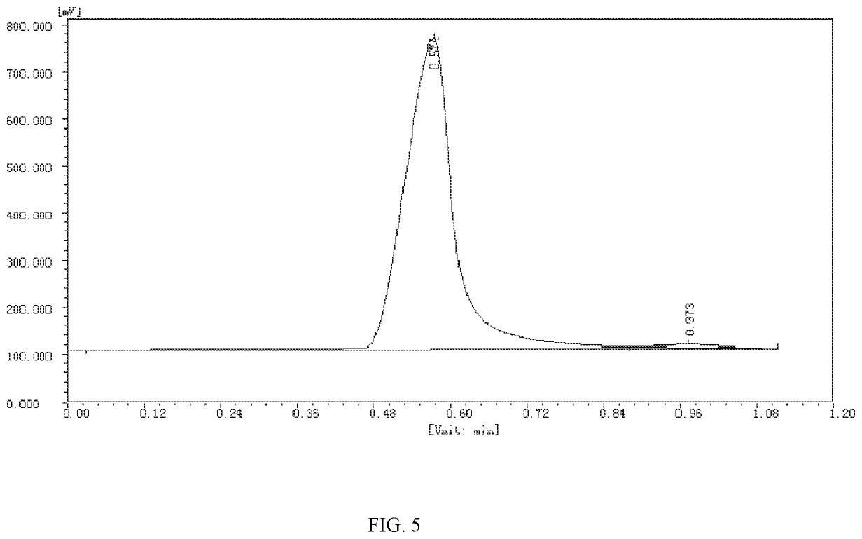

FIG. 5 is a TCD graph of high-purity hydrogen.

### EXAMPLE 4

Preparation of 2,5-furandicarboxylic acid (FDCA) coupled with hydrogen production by electrocatalytic oxidation of 5-hydroxymethyl furfural (HMF) with H-shaped electrolysis tank electrocatalytic membrane reactor

An electrocatalytic membrane reactor was constructed by using a porous titanium membrane supported in situ with a cobalt oxide nano catalyst as an anode, a stainless steel wire as a cathode and an H-shaped electrolysis tank. A diaphragm used a Nafion proton exchange membrane, a stable current was supplied by a direct current power supply, a membrane operation process used a dead end filtration mode, one end of the membrane was closed, the other end of the membrane was connected with a peristaltic pump through a pipeline, and a negative pressure was continuously supplied by the pump to enhance its mass transfer process. The initial concentration of 5-hydroxymethyl furfural was 20 mmolL⁻¹, the concentration of electrolyte was 4 gL⁻¹ NaOH, the current density of the membrane reactor was 2.0 mAcm⁻², the retention time was 15 min, the conversion rate of furfural was 99%, the selectivity of FDCA was 99%, and the hydrogen production rate was 90 mL/h. The electrochemical synthesis of HMF and production of high-purity hydrogen are realized.

1. A novel electrocatalytic membrane reactor, wherein an H-shaped electrolytic tank is adopted, a cathode chamber is isolated from an anode chamber through a diaphragm, a membrane electrode is used as an anode, an auxiliary electrode is used as a cathode, a direct-current regulated power supply supplies a constant current, and the flow of a reaction solution is realized through a pump.

2. The novel electrocatalytic membrane reactor according to claim 1, wherein the diaphragm is an ion exchange member or a proton exchange membrane.

3. The novel electrocatalytic membrane reactor according to claim 1, wherein the membrane electrode is a flat or tubular inorganic metal membrane, an oxide membrane or a carbon membrane.

4. The novel electrocatalytic membrane reactor according to claim 3, wherein the membrane electrode is supported with a notable metal and an oxide thereof as well as a transition metal oxide and a sulfide or a phosphide.

5. The novel electrocatalytic membrane reactor according to claim 1, wherein the cathode is a metal electrode or a graphite electrode.

6. A use of the novel electrocatalytic membrane reactor according to claim 1 in preparation of high-purity hydrogen.

7. The use according to claim 6, wherein high-purity hydrogen is prepared in the cathode chamber, and an electrochemical oxidation reaction is performed in the anode chamber.

8. The use according to claim 6, wherein the electrochemical oxidation reaction comprises an organic degradation reaction or an oxygen-containing compound preparation reaction.

9. The use according to claim 8, wherein the organic degradation comprises degradation of phenol and acid orange, and the oxygen-containing compound preparation comprises preparation of aldehyde and acid products by oxidation of benzyl alcohol, ethanol and furfural organics.
